(19) United States
(12) Patent Application Publication
(10) Pub. No.: US 2015/0327300 A1
(43) Pub. Date: Nov. 12, 2015

(54) VEHICLE-MOUNTED DEVICE, METHOD AND ARTICLE OF MANUFACTURE FOR CONTROLLING THE SAME

(71) Applicant: Transcend Information, Inc., Taipei City (TW)

(72) Inventors: Kuan-Jen CHEN, Yilan County (TW); Chia-Ming HU, New Taipei City (TW)

(73) Assignee: Transcend Information, Inc., Taipei City (TW)

(21) Appl. No.: 14/274,766

(22) Filed: May 11, 2014

(51) Int. Cl. H04W 76/02; H04W 8/22

(52) U.S. Cl. CPC H04W 76/02; H04W 8/22

(57) ABSTRACT

A vehicle-mounted device, a method and an article of manufacture for controlling the same are provided. The method for controlling the vehicle-mounted device storing at least one first parameter value therein includes steps as follows. At least one second parameter value is provided to a mobile device; the mobile device and the vehicle-mounted device are communicatively connected; a determination is made as to whether a difference exists between the first parameter value and the second parameter value; by replacing the first parameter value in the vehicle-mounted device with the second parameter value when the difference exists, the vehicle-mounted device is set according to the second parameter value such that the vehicle-mounted device operates according to the second parameter value.

### BACKGROUND

1. Field of Disclosure

The present disclosure relates to a method for controlling a vehicle-mounted device. More particularly, the present disclosure relates to a vehicle-mounted device, a method and an article of manufacture for controlling the same.

2. Description of Related Art

Recently, a vehicle-mounted driving recorder installed in motor vehicle can automatically record videos of outside or inside of the motor vehicle during driving. Thus, if an accident occurs, a driver of the motor vehicle can make an after-the-fact analysis by viewing an objective video recorded by the vehicle-mounted driving recorder at a time of an accident for safeguarding his/her rights.

Normally, for personalizing settings of the vehicle-mounted driving recorder, the vehicle-mounted driving recorder provides a console panel for parameter settings (e.g., video resolution, brightness or contrast etc.) of the vehicle-mounted driving recorder.

However, no matter how convenient the console panel is, it still takes time for a user to set these parameter settings thereof one by one by the console panel of the vehicle-mounted driving recorder, especially when the user is driving. Thus, it is necessary to provide a solution for quickly setting the vehicle-mounted driving recorder.

### SUMMARY

In view of the above, an object of the present disclosure is to provide a vehicle-mounted device, a method for controlling the same, and a non-transitory computer readable storage medium with an application program for executing the method for solving the mentioned disadvantages existed in prior art, that is, once the vehicle-mounted device is communicatively connected to a mobile device wired or wirelessly, at least one parameter value stored in the mobile device will be transmitted to the vehicle-mounted device for setting the vehicle-mounted device automatically.

In order to achieve the aforementioned object, according to an embodiment, a method for controlling a vehicle-mounted device in which the vehicle-mounted device is used to operate according to a first parameter set including at least one first parameter value, the method includes the following steps. A second parameter set including at least one second parameter value is provided to a mobile device when the mobile device is communicatively disconnected to the vehicle-mounted device. The mobile device and the vehicle-mounted device are communicatively connected together. Next, a determination is made as to whether a difference exists between the at least one first parameter value and the at least one second parameter value when the mobile device is communicatively connected to the vehicle-mounted device. Then, the at least one first parameter value is replaced with the at least one second parameter value in the vehicle-mounted device when the difference exists, thus, the vehicle-mounted device is set according to the replaced at least one second parameter value such that the vehicle-mounted device is able to operate according to the second parameter value.

According to another aspect in one or more embodiments, a vehicle-mounted device is provided with a function module, a connecting unit configured to be communicatively connecting with a mobile device, a storage unit configured to store at least one first parameter value therein, and a processing unit electrically connected to the function module, the storage unit and the connecting unit, and configured to (1) receive at least one second parameter value from the mobile device when the connecting unit communicatively connects to the mobile device, (2) determine whether a difference exists between the at least one first parameter value and the at least one second parameter value, (3) replace the at least one first parameter value in the storage unit with the at least one second parameter value, and (4) operate with the function module to provide a main function according to the replaced at least one second parameter value in the storage unit.

As what has been disclosed above, by the technical solution provided by the present disclosure, a user can set up at least one parameter value in a mobile device before the mobile device is able to communicatively connect to the vehicle-mounted device. Once the vehicle-mounted device communicatively connects to the mobile device, the mobile device can directly transmit the parameter value set up by the user to replace the original parameter value in the vehicle-mounted device automatically with or without instructions of the user. The user does not need to change the parameter value of the vehicle-mounted device one by one via a console panel thereof of the vehicle-mounted device. Thus, time for setting the vehicle-mounted device can be saved, and convenience of the setting can be improved. Also, the user will be safer when the user is driving.

The above description is merely used for illustrating the problems to be resolved, the technical methods for resolving the problems and their efficacies, etc. The specific details of the present disclosure will be explained in the below embodiments and related drawings.

### BRIEF DESCRIPTION OF THE DRAWINGS

The disclosure may be more fully understood by reading the following detailed description of the embodiment, with reference made to the accompanying drawings as follows:

FIG. 1 is a block diagram illustrating a vehicle-mounted device and a mobile device according to a first embodiment of the disclosure;

FIG. 2 is a flowchart illustrating a method for controlling the vehicle-mounted device according to the first embodiment of the disclosure;

FIG. 3 is a flowchart illustrating a method for controlling the vehicle-mounted device according to a variation of the first embodiment of the disclosure;

FIG. 4 is a schematic view of a query message shown on the mobile device according to a third embodiment of the disclosure;

FIG. 5 is a schematic view of a query message shown on the mobile device according to a variation of the third embodiment of the disclosure;

FIG. 6 is a block diagram illustrating a vehicle-mounted device and a mobile device according to a fourth embodiment of the disclosure;

FIG. 7 is a block diagram illustrating a vehicle-mounted device according to a fifth embodiment of the disclosure;

FIG. 8 is a schematic view of an interface of an application software executed on a display screen of the mobile device according to a sixth embodiment of the disclosure; and

FIG. 9 is a schematic view of an interface of an application software executed on the mobile device according to a seventh embodiment of the disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the drawings, some of the conventional structures and elements are shown with schematic illustrations.

Embodiments may be implemented as a method and/or an apparatus or article of manufacture having stored thereon one or more machine executable instructions and/or data files which (when executed by appropriate machine) cause the machine to perform the described method. The term “article of manufacture” as used herein is intended to encompass one or more machine-readable medium (devices, carriers, or media), including, for example, a magnetic storage media, “floppy disk”, CD-ROM, RAM, a PROM, an EPROM, a FLASH-EPROM, any other memory chip or cartridge, a file server providing access to the programs via a wired/wireless network transmission line, a memory module within an integrated circuit, etc. The machine that executes the machine executable instructions (software, program, etc.) stored on the machine-readable medium can be any electronic device capable of executing the instructions of a computer program stored on the machine-readable media. Of course, those skilled in the art will recognize that many modifications and variation may be made to this configuration without departing from the scope of the present invention.

### First Embodiment

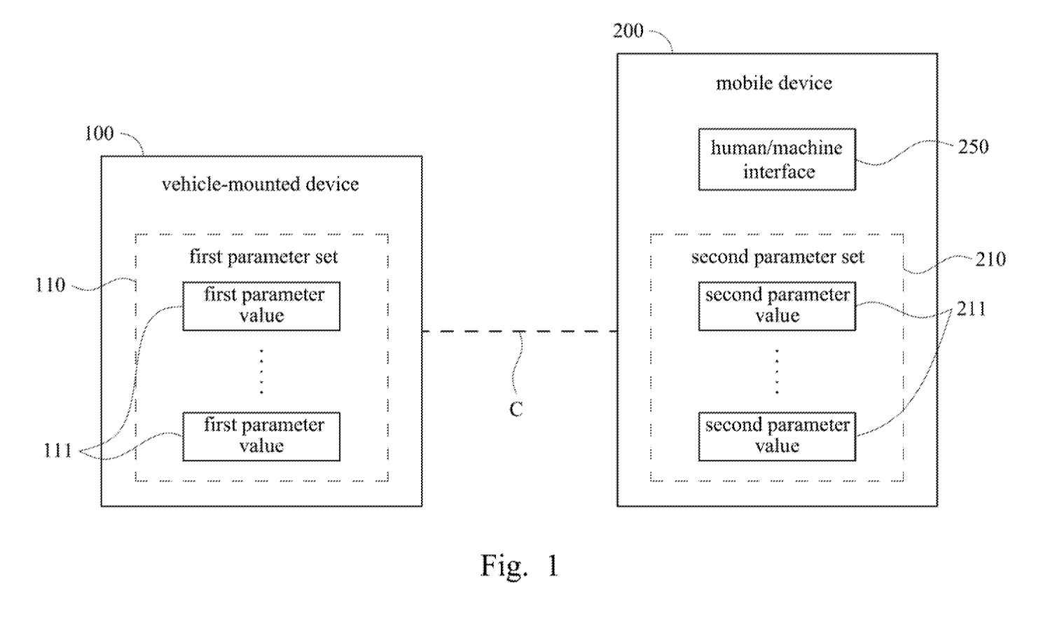

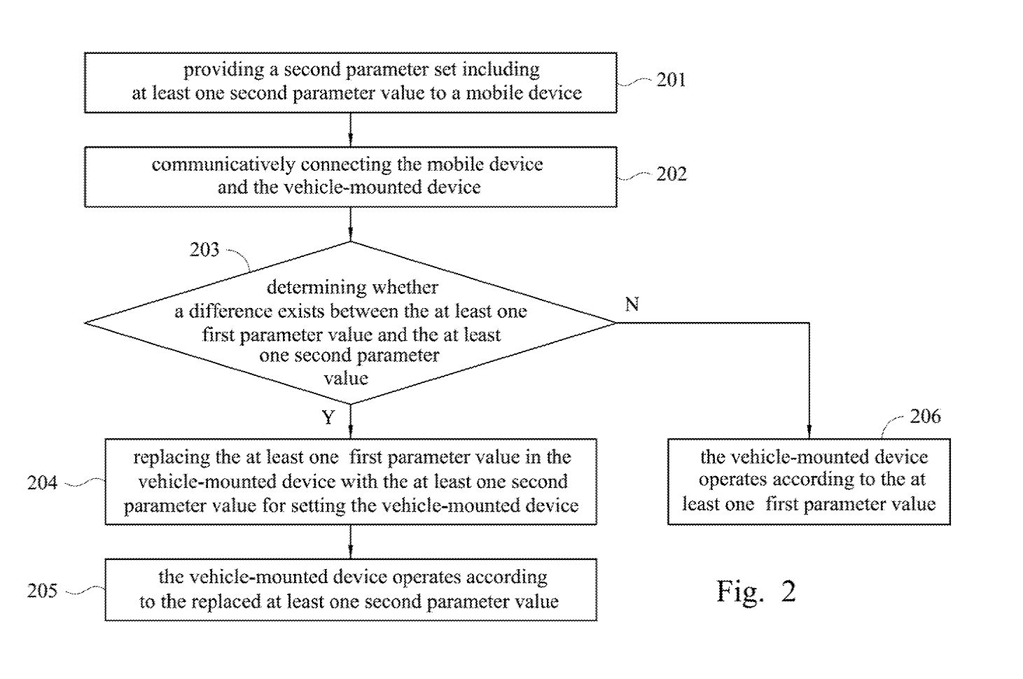

Reference is now made to FIG. 1 and FIG. 2 in which FIG. 1 is a block diagram illustrating a vehicle-mounted device 100 and a mobile device 200 according to a first embodiment of the disclosure, and FIG. 2 is a flowchart illustrating a method for controlling the vehicle-mounted device 100 according to the first embodiment of the disclosure.

In the first embodiment, a method for controlling a vehicle-mounted device 100 is provided, in which the vehicle-mounted device 100 stores a first parameter set 110 including at least one first parameter value 111 therein, so that the vehicle-mounted device 100 operates according to the at least one first parameter value 111. The method for controlling the vehicle-mounted device 100 includes steps 201 to 206 outlined as follows.

In step 201, a second parameter set 210 including at least one second parameter value 211 is previously provided to a mobile device 200. In step 202, the mobile device 200 is communicatively connected to the vehicle-mounted device 100 through a wired/wireless connection C and the at least one second parameter value 211 is transmitted to the vehicle-mounted device 100. It is noted that the mobile device 200 can communicatively connect to the vehicle-mounted device 100 through a cable of Universal Serial Bus (USB) or alike, or via a wireless connection of Bluetooth®, Wi-Fi® or alike. In step 203, it is determined whether a difference exists between the least one first parameter value 111 and the at least one second parameter value 211. If it is determined that the difference exists between the at least one first parameter value 111 and the at least one second parameter value 211, the method continues to step 204, where the at least one first parameter value 111 in the vehicle-mounted device 100 is replaced with the at least one second parameter value 211 for subsequently processing, so that the vehicle-mounted device 100 is set according to the at least one second parameter value 211 received from vehicle-mounted device 100. Next, in step 205, the vehicle-mounted device 100 can operate according to the replaced second parameter value 211 of the second parameter set 210 previously stored in the vehicle-mounted device 100. Otherwise, if it is determined that the difference does not exist between the at least one first parameter value 111 and the at least one second parameter value 211, the method continues to step 206, where the vehicle-mounted device 100 operates according to the at least one first parameter value 111 of the first parameter set 110 previously stored in the vehicle-mounted device 100.

Since the at least one second parameter value 211 for changing the settings of the vehicle-mounted device 100 can be provided to the mobile device 200 before communicatively connecting with the vehicle-mounted device 100, once the vehicle-mounted device 100 and the mobile device 200 are communicatively connected together, the mobile device 200 can automatically replace the at least one first parameter value 111 with the at least one second parameter value 211 and set the vehicle-mounted device 100 without waiting for user to reset the at least one first parameter value 111 via a console panel of the vehicle-mounted device 100.

Moreover, if some users use the same vehicle-mounted device 100 in turn, each user can input the suitable at least one second parameter value 211 in his/her own mobile device 200 in advance. Once one of the mobile devices 200 is communicatively connected to the vehicle-mounted device 100, the vehicle-mounted device 100 can receive the at least one second parameter value 211 from the mobile device 200 and automatically be set accordingly, so that this user does not have to manually reset the at least one first parameter value of the vehicle-mounted device again. Therefore, the method in the embodiment can simplify the process of frequently setting the vehicle-mounted device 100, making multiple users to use the vehicle-mounted device 100 according to his/her preference more conveniently. However, in order to prevent from interference by multiple mobile devices 200 connecting to the vehicle-mounted device at the same time, the vehicle-mounted device 100 is programmed to refuse other mobile devices to communicatively connect thereto when there is one mobile device 200 which has already communicatively connected thereto.

Specifically, in step 201 of the first embodiment, the at least one second parameter value 211 of the second parameter set 210 can be inputted to the mobile device 200 manually in advance from its human/machine interface 250. When the at least one of the second parameter value 211 of the second parameter set 210 is inputted to the mobile device 200, a background information (e.g., modification time, size and types) of the at least one second parameter value 211 can be instantly logged therewith in the mobile device 200. However, the invention is not limited thereto, in other embodiment, the second parameter set 210 also can be built-in in the mobile device 200 already, or given from the exterior of the mobile device 200.

Step 202 of the first embodiment is further described with more details as follows. First, the mobile device 200 searches the vehicle-mounted device 100 and determines whether the vehicle-mounted device 100 can be wirelessly connected by such as Wi-Fi® or Bluetooth® technology. If the mobile device 200 determines that the vehicle-mounted device 100 can be wirelessly connected, such as the vehicle-mounted device 100 authenticates the mobile device 200 for accessing to the vehicle-mounted device 100, the mobile device 200 is able to exchange information with the vehicle-mounted device 100 wirelessly, that is, the mobile device 200 is able to transmit the at least one second parameter value 211 to the vehicle mounted device 100. It is noted that the at least one second parameter value 211 can be packed into a configuration file, then the entire configuration file is transmitted to the vehicle-mounted device 100, and after the configuration file is transmitted from the mobile device 200 to the vehicle-mounted device 100, the at least one second parameter value 211 packed in the configuration file is unpacked for continuing to the determination step (step 203). The vehicle-mounted device 100 may authenticate the mobile device 200 by verifying identification numbers, account names and passwords, or other authentication information submitted from the mobile device 200. However, the invention is not limited thereto. In other embodiment, the mobile device 200 also can be communicatively connected to the vehicle-mounted device 100 wiredly. For example, the mobile device 200 can be communicatively connected to the vehicle-mounted device 100 with a cable (e.g., Ethernet cable or USB cable).

Step 203 of the first embodiment is described with more details as follows. First, after the mobile device 200 transmits the at least one second parameter value 211 to the vehicle-mounted device 100, the vehicle-mounted device 100 compares a modification time of the at least one first parameter value 111 and a modification time of the at least one second parameter value 211, and then determines whether the modification time of the at least one first parameter value 111 and the modification time of the at least one second parameter value 211 are different. If the vehicle-mounted device 100 determines that the modification time of the at least one first parameter value 111 is different to the modification time of the at least one second parameter value 211, for example, the modification time of the at least one first parameter value 111 is prior to the modification time of the at least one second parameter value 211, the method continues step 204 for subsequently processing. On the other hand, if the vehicle-mounted device 100 determines that the modification time of the at least one first parameter value 111 and the modification time of the at least one second parameter value 211 are identical, the method continues step 206. When the modification time of the at least one first parameter value 111 and the modification time of the at least one second parameter value 211 are determined to be identical, the vehicle-mounted device 100 may discard or store the at least one second parameter value 211.

However, the invention is not limited thereto. In other embodiments, the vehicle-mounted device 100 also can compare a content of the at least one first parameter value 111 and a content of the at least one second parameter value 211, and determine whether a difference exists between the content of the at least one first parameter value 111 and the content of the at least one second parameter value 211. For example, the vehicle-mounted 100 compares a checksum of the content of the at least one first parameter value 111 and a checksum of the content of the at least one second parameter value 211 to determine whether the checksum of the content of the first parameter value at least one 111 and the checksum of the content of the at least one second parameter value 211 are different. If the vehicle-mounted device 100 determines that the checksum of the content of the at least one first parameter value 111 and the checksum of the content of the at least one second parameter value 211 are different, that is, the content of the at least one first parameter value 111 and the content of the at least one second parameter value 211 are different, the method continues to step 204 for subsequently processing. On the other hand, if the mobile device 200 determines that the checksum of the content of the at least one first parameter value 111 and the checksum of the content of the at least one second parameter value 211 are identical, that is, the content of the at least one first parameter value 111 and the content of the at least one second parameter value 211 are not different, the method continues to step 206. When the content of the at least one first parameter value 111 and the content of the at least one second parameter value 211 are determined to be identical, the vehicle-mounted device 100 may discard or store the at least one second parameter value 211.

In the first embodiment, if the vehicle-mounted device 100 determines in step 203 that a difference exists between the at least one first parameter value 111 and the at least one second parameter value 211, in step 204, the at least one first parameter value 111 is replaced with the at least one second parameter value 211 without any user instruction.

A follow-up step can be optionally provided after step 204 as to report a message to either the mobile device 200 only, the vehicle-mounted device 100 only, or both of the mobile device 200 and the vehicle-mounted device 100 in which the message notifies that the vehicle-mounted device 100 is finished setting according to the at least one second parameter value. Thus, the user can be aware that the setting of the vehicle-mounted device 100 has been updated lately from the mobile device 200 only, the vehicle-mounted device 100 only, or both of the mobile device 200 and the vehicle-mounted device 100. However, the message is not an essential requirement in the invention, and can be omitted for decreasing the complexity of the process.

When the vehicle-mounted device 100 starts to operate in accordance with the at least one second parameter value 211 or the at least one first parameter value 111 in step 205 or step 206, the user can control the vehicle-mounted device 100 by the mobile device 200. For example, the user can browse information stored in the vehicle-mounted device 100 by the human/machine interface 250 of the mobile device 200 in which the information includes the at least one second parameter value 211 or the at least one first parameter value 111, or other documents in the vehicle-mounted device 100; or the user can reset the vehicle-mounted device 100 by the human/machine interface 250 of the mobile device 200 again when the mobile device 200 is communicatively connecting with the vehicle-mounted device 100; or the user can communicatively disconnects the mobile device 200 from the vehicle-mounted device 100 by the human/machine interface 250 of the mobile device 200.

### Second Embodiment

It is noted that in the first embodiment, the mobile device 200 transmits the at least one second parameter value 211 to the vehicle-mounted device 100 after communicatively connecting therewith in step 202, then the vehicle-mounted device 100 determines whether a difference exists between the at least one first parameter value 111 and the at least one second parameter value 211. However, the present invention is not limited thereto. Refer to FIG. 1 and FIG. 2, similar to the method of the first embodiment, steps 201 to 206 may also be performed in the second embodiment, while in step 202, the mobile devices 200 receives the at least one first parameter value 111 from the vehicle-mounted device 100 after communicatively connecting therewith, then in step 203, the mobile device 200 determines whether a difference exists between the at least one first parameter value 111 and the at least one second parameter value 211. Similar to the first embodiment, the mobile devices 200 in the second embodiment determines whether a different exists between the modification time of the at least one first parameter value 111 and the modification time of the at least one second parameter value 211, or the content of the at least one first parameter value 111 and the content of the at least one second parameter value 211.

In step 204, the mobile device 200 transmits the aforementioned configuration file consisting of the at least one second parameter value 211 to the vehicle-mounted device 100 for replacing the at least one first parameter value 111 after the difference exists between the at least one first parameter value 111 and the at least one second parameter value 211 by the mobile device 200.

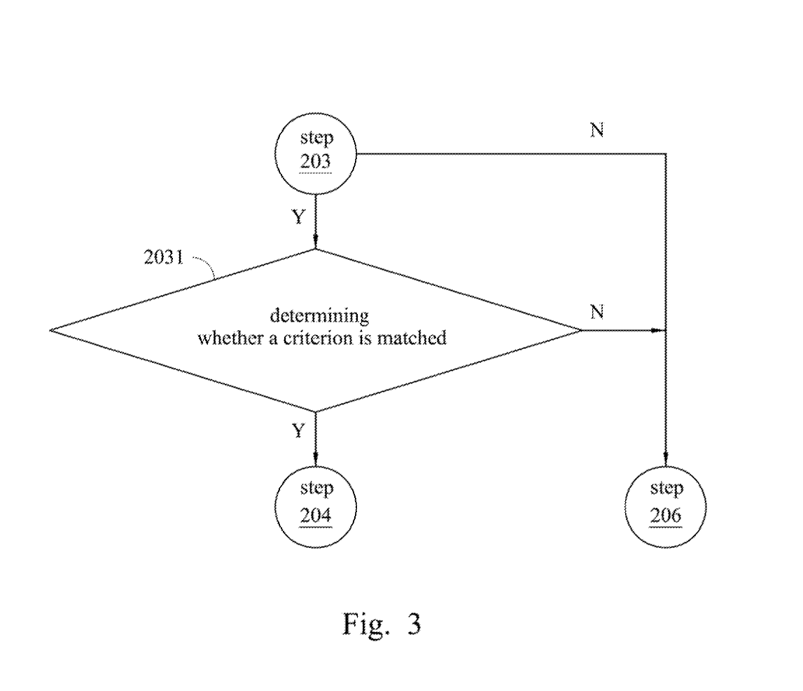

FIG. 3 is a flowchart illustrating a method for controlling the vehicle-mounted device according to an option of the first embodiment or the second embodiment of the disclosure. As shown in FIG. 3, even though the difference exists between the at least one first parameter value 111 and the at least one second parameter value 211 by step 203, an extra step 2031 of “determining whether a criterion is matched” can be added in the method of the first embodiment between step 203 and step 204. If the mobile device 200 or the vehicle-mounted device 100 determines that the criterion is matched, the method continues step 204 for subsequently processing. Otherwise, the method still continues step 206 although the difference does exists between the at least one first parameter value 111 and the at least one second parameter value 211.

The criterion is used to ensure that the at least one second parameter value 211 is favorable to the user although the difference exists between the at least one first parameter value 111 and the at least one second parameter value 211. For example, if the modification time of the at least one first parameter value 111 is relatively late to the modification time of the at least one second parameter value 211, the at least one first parameter value 111 might be more favorable to the user. Thus, it is unreasonable to replace the relative new parameter value with the older one.

### Third Embodiment

Refer to FIG. 1 and FIG. 2, in the first embodiment or the second embodiment even the difference exists between the at least one first parameter value 111 and the at least one second parameter value 211, the at least one second parameter value 211 may not always favorable to the user, or may not be correctly functioned by the vehicle-mounted device. Thus, in the second embodiment, a user of the mobile device 200 is allowed to select at least one of the second parameter values 211 or the least one first parameter value 111 to be used for setting the vehicle-mounted device 100.

The method of the third embodiment is similar to the method of the first embodiment or the second embodiment. However, a follow-up step is further provided between step 203 and step 204, as to select the at least one second parameter value 211 or the at least one first parameter value 111 for a setting of the vehicle-mounted device 100 according to a user instruction signal receiving from the mobile device 200.

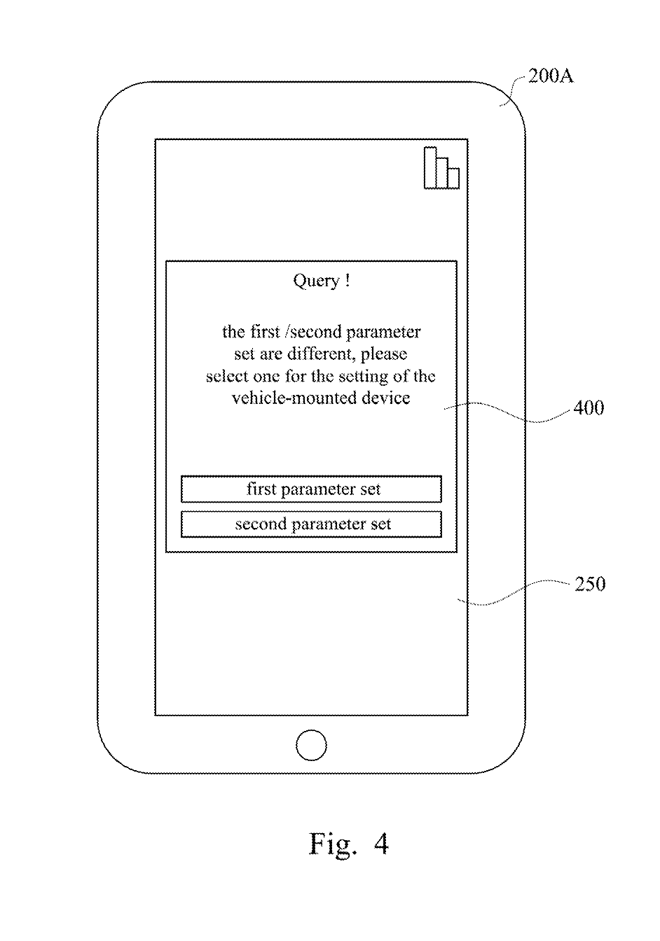

FIG. 4 is a schematic view of a query message 400 shown on the mobile device 200A according to a third embodiment of the disclosure. Refer to FIG. 1 and FIG. 4. Specifically, the vehicle-mounted device 100 or the mobile device 200A can be programmed to provide a query message 400 to the human/machine interface 250 (i.e., display screen) of the mobile device 200A for requesting to select the second parameter set or the first parameter set to be used to operate the vehicle-mounted device 100 after it is determined that a difference exists between the at least one first parameter value 111 and the at least one second parameter value 211.

Thus, when the user selects the second parameter set 210 on the query message 400, a corresponding user instruction signal is inputted through the human/machine interface 250 of the mobile device 200A, so that the at least one second parameter value 211 in the second parameter set 210 can be selected to set the vehicle-mounted device 100 as step 204 of FIG. 2 does. Otherwise, when the user selects the first parameter set 110 on the query message 400, a corresponding user instruction signal is inputted through the human/machine interface 250 of the mobile device 200A, so that the vehicle-mounted device 100 remains operating according to the at least one first parameter value 111 in the first parameter set 110 as step 205 of FIG. 2 does.

It is noted that the invention is not limited thereto, in other embodiments, the vehicle-mounted device 100 or the mobile device 200A can be additionally or alternatively programmed to provide a query message 400 to the human/machine interface (not shown) of the vehicle-mounted device 100.

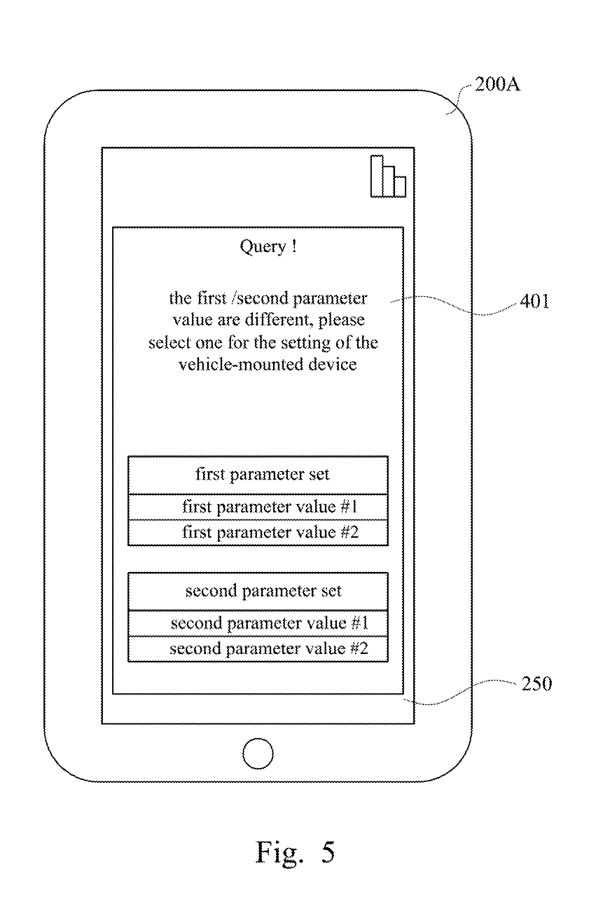

FIG. 5 is a schematic view of a query message 401 shown on the mobile device 200A according to a variation of the third embodiment of the disclosure. Other than selecting the second parameter set 210 or the first parameter set 110 in its entirety, refer to FIG. 1 and FIG. 5, the vehicle-mounted device 100 or the mobile device 200 can be programmed to provide a query message 401 to the human/machine interface 250 (i.e., display screen) of the mobile device 200A for requesting to provide a query message 401 for requesting to select which at least one parameter value in the second parameter set 210 and/or which at least one first parameter value 111 in the first parameter set 110 is to be used in the vehicle-mounted device 100 once the difference existing between the at least one first parameter value 111 and the at least one second parameter value 211 is determined.

For example, the at least one first parameter value 111 and the at least two second parameter value 211 which are determined to be different to each other can be respectively shown on the query message 401 on the human/machine interface 250 (i.e., display screen) of the mobile device 200A. Thus, the user can selects at least one desired parameter value respectively among the at least one first parameter value 111 and the at least one second parameter value 211 on the query message 401.

Thus, when the user selects at least one desired parameter value on the query message 401, a corresponding user instruction signal is inputted through the human/machine interface 250 of the mobile device 200A, so that at least one second parameter value 211 in the user-selected at least one desired parameter value can be selected to set the vehicle-mounted device 100 as step 204 of FIG. 2 does. As for at least one first parameter value 111 among the user-selected at least one desired parameter value, the vehicle-mounted device 100 remains operating according to the at least one first parameter value 111 in the first parameter set 110.

It is also noted that the invention is not limited thereto, in other embodiments, the vehicle-mounted device 100 or the mobile device 200A can be additionally or alternatively programmed to provide a query message 401 to the human/machine interface (not shown) of the vehicle-mounted device 100 (not shown) for the user to select at least one parameter value that he/she desires.

### Fourth Embodiment

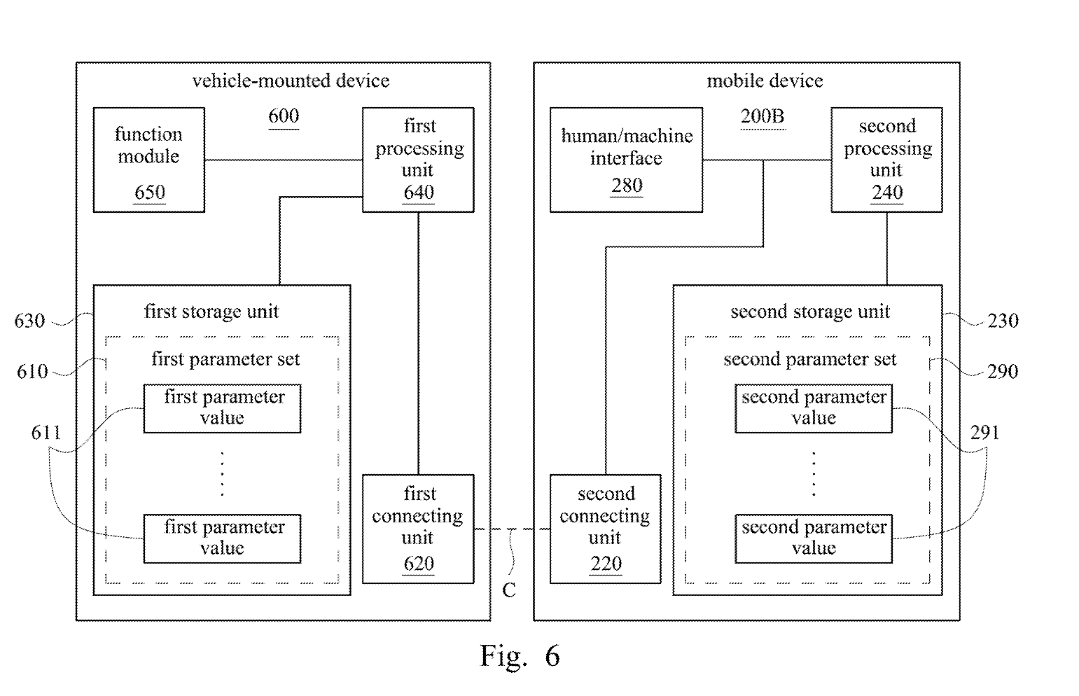

Reference is now made to FIG. 6 in which FIG. 6 is a block diagram illustrating a vehicle-mounted device 600 and a mobile device 200B according to a fourth embodiment of the disclosure. In the fourth embodiment, the vehicle-mounted device 600 and the mobile device 200B may implement the above embodiments. The vehicle-mounted device 600 includes a function module 650, a first connecting unit 620, a first storage unit 630 and a first processing unit 640. The first connecting unit 620 is communicatively connected to a second connecting unit 220 of the mobile device 200B through a wired/wireless connection C. The first storage unit 630 stores the at least one first parameter value 611 of the first parameter set 610. The first processing unit 640 is electrically connected to the function module 650, the first storage unit 630 and the first connecting unit 620. The function module 650 is used to provide a necessary component, such as video capturing module, navigation database module, and acceleration sensing module, such that the first processing unit 640 can operate with the function module 650 according to the at least one first parameter value 611 of the first parameter set 610 storing in the first storage unit 630 to provide a main function. The main function of the vehicle-mounted device 600 can be video capturing, navigating or acceleration sensing etc.

The mobile device 200B includes a human/machine interface 280, the second connecting unit 220, a second storage unit 230 and a second processing unit 240. The human/machine interface 280 can be used to select at least one parameter value, in which the human/machine interface 280 can be a touch panel display, a touch pad, a keyboard or a voice command interface. The second connecting unit 220 of the mobile device 200B is communicatively connected to the first connecting unit 620 of the vehicle-mounted device 600 wiredly or wirelessly so that the vehicle-mounted device 600 and the mobile device 200B can exchange information with each other via the first connecting unit 620 and the second connecting unit 220. The second storage unit 230 stores a second parameter set 290 having the at least one second parameter value 291. The second processing unit 240 is electrically connected to the human/machine interface 280, the second connecting unit 220, and the second storage unit 230.

When the first connecting unit 620 communicatively connects to the second connecting unit 220, the second processing unit 240 is able to access to the at least one first parameter value 611 stored in the first storage unit 630, and determine whether a difference exists between the at least one first parameter value 611 and the at least one second parameter value 291. If it is determined that the difference exists between the at least one first parameter value 611 and the at least one second parameter value 291, the second processing unit 240 transmits the previously created at least one second parameter value 291 to the vehicle-mounted device 600 through the wired/wireless connection C, and requests the first processing unit 640 to replace the at least one first parameter value 611 with the at least one second parameter value 291. The previously created at least one second parameter value 291 can be packed into a configuration file then transmitted to the vehicle-mounted device 600. The configuration file may comprise all of the at least one second parameter value 291 of the second parameter set if the at least one second parameter value 291 is plural, or only comprises the at least one second parameter value 291 which is different from the at least one first parameter value 611.

When the first processing unit 640 receives the at least one second parameter value 291 from the mobile device 200B, the first processing unit 640 replaces the at least one first parameter value 611 in the first storage unit 630 with the at least one second parameter value 291 in the configuration file. Then, the first processing unit 640 operates with the function module 650 according to the at least one second parameter value 291 replaced in the first storage unit 630 to provide the main function.

Although the vehicle-mounted device 600 can be practiced without a human/machine interface in FIG. 6, however, the invention is not limited thereto, in other embodiments, the vehicle-mounted device also can be provided with a human/machine interface (not shown) which is electrically connected to the first processing unit and is used to input and select parameter values, and show the above query message; or in other embodiments, both of the vehicle-mounted device and the mobile device can have a respective human/machine interface.

### Fifth Embodiment

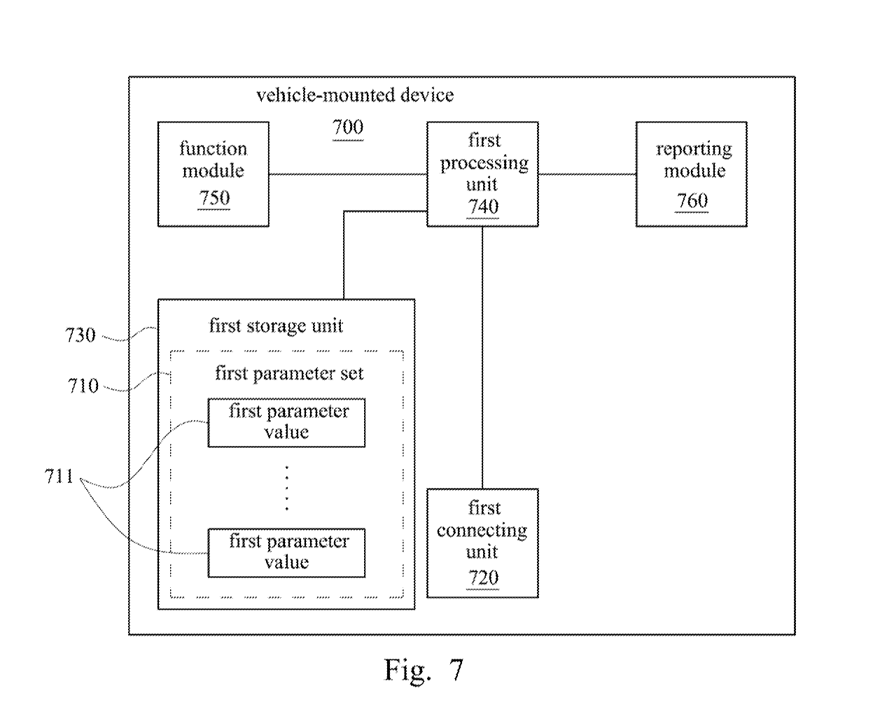

FIG. 7 is a block diagram illustrating a vehicle-mounted device 700 according to a fifth embodiment of the disclosure. The vehicle-mounted device 700 of the fifth embodiment is substantially the same as the vehicle-mounted device 600 of the fourth embodiment except that a reporting module 760 is additionally provided in the vehicle-mounted device 700. The reporting module 760 electrically connects to the first processing unit 740, and reports a message that the vehicle-mounted device 700 is finished setting after the at least one first parameter value 711 is replaced with the at least one second parameter value 291 (FIG. 6) to the user. The reporting module 760 includes, for example, a display screen, a speaker, an indication light, or a combination thereof.

Although the mobile device of the fifth embodiment can be practiced without a reporting module, however, the invention is not limited thereto, in other embodiments, the mobile device also can be provided with a reporting module (not shown) which is electrically connected to the second processing unit and is used to report the message that the vehicle-mounted device 700 is finished setting after the at least one first parameter value 711 is replaced with the at least one second parameter value 291 to the user; or in other embodiments, both of the vehicle-mounted device and the mobile device can have a respective reporting module for reporting the above messages to the user.

### Sixth Embodiment

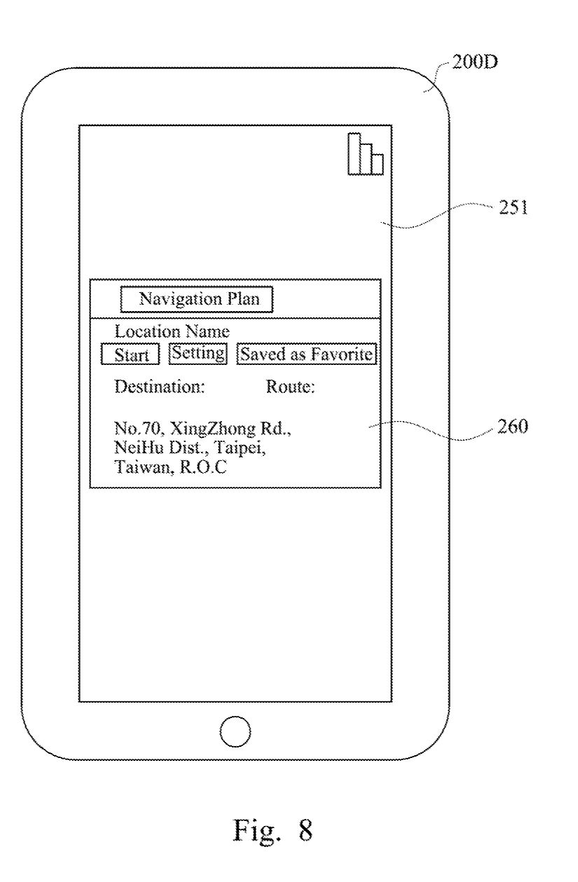

FIG. 8 is a schematic view of an interface of an application software executed on the mobile device 200D according to a sixth embodiment of the disclosure. Refer to FIG. 7 and FIG. 8, in the sixth embodiment, the vehicle-mounted device 700 is a navigation device, and the navigation device is able to implement the aforementioned disclosure from those embodiments above in which the methods of those embodiments can be developed as application software for controlling a navigation device remotely.

For example and referring to FIG. 8, after the application software is downloaded from an the Internet, the application software can be stored in the mobile device 200D, and executed by the mobile device 200D to provide a software interface 260 shown on a display screen 251 of the mobile device 200D.

By the software interface 260, a user can input at least one second parameter value in which the number of the at least one second parameter value is not limited. The at least one second parameter value can be, for example, at least one starting-point, at least one destination-point, at least one stop point, or at least one navigation route or any combination thereof.

However, in practice, when the at least one second parameter value is plural, the navigation device might not allow all of the second parameter values from the mobile device 2000 to be totally replaced the first parameter values in some reasons such as safety or compatibility considerations. Thus, some of the second parameter values might not be able to be replaced the corresponding first parameter values, respectively.

Furthermore, after the mobile device 200D communicatively connects to the navigation device, the mobile device 200D can be used to remotely control the navigation device for operating. For example, the mobile device 200D can be used to browse information stored in the navigation device, or used to reset the setting of the navigation device again, or communicatively disconnect to the navigation device.

### Seventh Embodiment

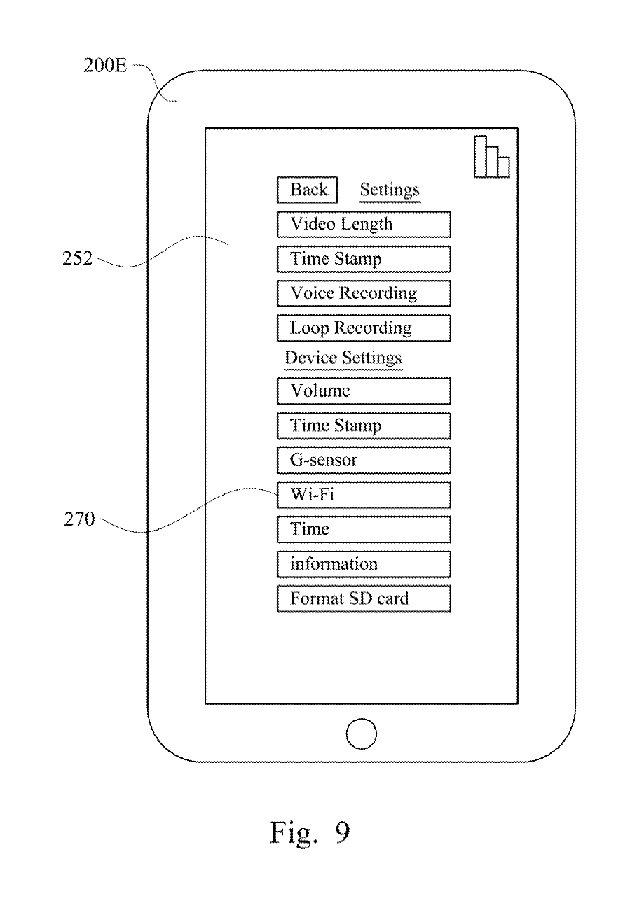

FIG. 9 is a schematic view of an interface of an application software executed on the mobile device 200E according to a seventh embodiment of the disclosure. In the seventh embodiment, the vehicle-mounted device 200E is a driving recorder or a navigation device having a driving recorder thereon, and the driving recorder is able to implement the aforementioned disclosure from those embodiments above in which the methods of those embodiments can be developed as application software for controlling a driving recorder remotely.

For example and referring to FIG. 9, after the application software is downloaded from the Internet, the application software can be stored in the mobile device 200E, and executed by the mobile device 200E to provide a software interface 270 shown on a display screen 252 of the mobile device 200E.

By the software interface 270, a user can input at least one second parameter value in which the number of the at least one second parameter value is not limited. The at least one second parameter value can be, for example, time, date, video resolution, brightness, contrast, video resolution adjustment timetable, recording format, volume, video length and G-sensor sensitivity level, or any combination thereof. However, in practice, when the at least one second parameter value is plural, the driving recorder might not allow all of the second parameter values from the mobile device 200E to totally replace the first parameter values in some reasons such as safety or compatibility considerations. Thus, some of the second parameter values might not be able to replace the corresponding at least one first parameter values, respectively.

Furthermore, after the mobile device 200E communicatively connects to the driving recorder, the mobile device 200E can be used to remotely control the driving recorder for operating. For example, the mobile device 200E can be used to browse information stored in the driving recorder, or reset the setting of the driving recorder again, or communicatively disconnect to the driving recorder.

To be noted, the aforementioned mobile device is not limited to a certain type, and for example, the aforementioned mobile device can be selected from a group comprising of a notebook computer, a digital camera, a mobile phone, a panel computer and other similar portable devices.

Finally, the embodiments in the foregoing are not used for limiting the present disclosure, various modifications and variations may be made to the structure of the present disclosure are protected in the present disclosure by those skilled in this art without departing from the scope or spirit of the disclosure. Therefore, the scope of patent protection of the present disclosure is based on the scope of the attached patents.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for controlling a vehicle-mounted device in which the vehicle-mounted device is used to operate according to a first parameter set including at least one first parameter value, and the method comprising:
providing a second parameter set including at least one second parameter value to a mobile device when the mobile device is disconnected to the vehicle-mounted device;
communicatively connecting the mobile device and the vehicle-mounted device;
determining whether a difference exists between the at least one first parameter value and the at least one second parameter value; and
setting the vehicle-mounted device according to the at least one second parameter value by replacing the at least one first parameter value in the vehicle-mounted device with the at least one second parameter value when the difference exists, such that the vehicle-mounted device is able to operate according to the second parameter value.

2. The method for controlling a vehicle-mounted device of claim 1, wherein the step of communicatively connecting the mobile device and the vehicle-mounted device further comprises:
searching the vehicle-mounted device by the mobile device in a wireless network; and
authenticating the mobile device by the vehicle-mounted device to access thereto.

3. The method for controlling a vehicle-mounted device of claim 1, wherein the step of communicatively connecting the mobile device and the vehicle-mounted device is performed with a cable.

4. The method for controlling a vehicle-mounted device of claim 1, wherein the step of communicatively connecting the mobile device and the vehicle-mounted device comprises:
denying other mobile devices communicatively connecting to the vehicle-mounted device.

5. The method for controlling a vehicle-mounted device of claim 1, wherein the step of determining whether the difference exists between the at least one first parameter value and the at least one second parameter value is performed by one of the mobile device and the vehicle-mounted device.

6. The method for controlling a vehicle-mounted device of claim 1, wherein the step of determining whether the difference exists between the at least one first parameter value and the at least one second parameter value comprises:
comparing a modification time of the at least one first parameter value and a modification time of the at least one second parameter value by one of the mobile device and the vehicle-mounted device; and
determining whether a difference exists between the modification time of the at least one first parameter value and the modification time of the at least one second parameter value by one of the mobile device and the vehicle-mounted device.

7. The method for controlling a vehicle-mounted device of claim 1, further comprising:
reporting a message of finishing setting the vehicle-mounted device by at least one of the mobile device and the vehicle-mounted device after setting the vehicle-mounted device.

8. The method for controlling a vehicle-mounted device of claim 1, further comprising:
providing by at least one of the mobile device and the vehicle-mounted device a query message for requesting to select which at least one parameter value among the at least one second parameter value or the at least one first parameter value is to be used in the vehicle-mounted device once the difference existing between the at least one first parameter value and the at least one second parameter value is determined.

9. The method for controlling a vehicle-mounted device of claim 1, further comprising:
providing by at least one of the mobile device and the vehicle-mounted device a query message for requesting to select whether the first parameter set or the second parameter set is to be used in the vehicle-mounted device once the difference existing between the at least one first parameter value and the at least one second parameter value is determined.

10. The method for controlling a vehicle-mounted device of claim 1, further comprising:
transmitting a configuration file consisting of a plurality of the second parameter values from the mobile device to the vehicle-mounted device before replacing the at least one first parameter value in the vehicle-mounted device with the at least one second parameter value.

11. The method for controlling a vehicle-mounted device of claim 1, further comprising:
determining whether a criterion is matched after determining the difference exists between the at least one first parameter value and the at least one second parameter value.

12. The method for controlling a vehicle-mounted device of claim 1, wherein the vehicle-mounted device is a navigation device, and the at least one second parameter value and the at least one first parameter value is selected from a group consisted of starting-point, at least one destination-point, at least one stop point, at least one navigation route plan, and at least one My Favorite.

13. The method for controlling a vehicle-mounted device of claim 1, wherein the vehicle-mounted device is a driving recorder, and the at least one second parameter value and the at least one first parameter value is selected from a group consisted of time, date, video resolution, brightness, contrast, video resolution adjustment timetable, recording format, volume, video length and G-sensor sensitivity level.

14. A vehicle-mounted device comprising:
a function module;
a connecting unit configured to be communicatively connecting with a mobile device;
a storage unit configured to store at least one first parameter value therein; and
a processing unit electrically connected to the function module, the storage unit and the connecting unit, and configured to:
receive at least one second parameter value from the mobile device when the connecting unit communicatively connects to a mobile device;
determine whether a difference exists between the at least one first parameter value and the at least one second parameter value;
replace the at least one first parameter value in the storage unit with the at least one second parameter value; and
operate with the function module to provide a main function according to the replaced at least one second parameter value in the storage unit.

15. The vehicle-mounted device of claim 14, wherein the processing unit is configured to:
compare a modification time of the at least one first parameter value and a modification time of the at least one second parameter value; and
determine whether a difference exists between the modification time of the at least one first parameter value and the modification time of the at least one second parameter value.

16. The vehicle-mounted device of claim 14, wherein the processing unit is configured to:
report a message of finishing replacing the at least one first parameter value with the at least one second parameter value after the at least one first parameter value is replaced.

17. The vehicle-mounted device of claim 14, wherein the processing unit is configured to:
provide a query message for requesting to select which at least one parameter value among the at least one second parameter value or the at least one first parameter value is to be used in the vehicle-mounted device once the difference existing between the at least one first parameter value and the at least one second parameter value is determined.

18. The vehicle-mounted device of claim 14, wherein the processing unit is configured to:
provide a query message for requesting to select whether the first parameter set or the second parameter set is to be used in the vehicle-mounted device once the difference existing between the at least one first parameter value and the at least one second parameter value is determined.

19. An article of manufacture adapted to operate a vehicle-mounted device storing a first parameter set including at least one first parameter value therein, the article of manufacture comprising:
a non-transitory computer-readable storage medium configured to be installed in a mobile device and having computer-readable instructions stored thereon that are executable by a process unit to:
providing a second parameter set including at least one second parameter value to a mobile device when the mobile device is disconnected to the vehicle-mounted device;
communicatively connecting the mobile device and the vehicle-mounted device;
determining whether a difference exists between the at least one first parameter value and the at least one second parameter value; and
setting the vehicle-mounted device according to the at least one second parameter value by replacing the at least one first parameter value in the vehicle-mounted device with the at least one second parameter value when the difference exists, such that the vehicle-mounted device is able to operate according to the second parameter value.
